(19) United States
(12) Patent Application Publication
(10) Pub. No.: US 2026/0346934 A1
(43) Pub. Date: Nov. 5, 2026

(54) SYSTEM AND METHOD FOR ASSEMBLING VEHICLE

(71) Applicant: Ford Global Technologies, LLC, Dearborn, MI (US)

(72) Inventors: Kevin Young, Amherstburg (CA); Benjamin Hensel, Ann Arbor, MI (US); Andrew Reimer, Newport Beach, CA (US); Heather Adams, New Baltimore, MI (US)

(73) Assignee: Ford Global Technologies, LLC, Dearborn, MI (US)

(21) Appl. No.: 19/198,767

(22) Filed: May 5, 2025

(51) Int. Cl. B62D 65/02

(52) U.S. Cl. CPC B62D 65/026

(57) ABSTRACT

The present disclosure provides a method for assembling a vehicle that includes disposing at least one vehicle component of the vehicle onto a platform, disposing a vehicle frame of the vehicle onto the platform after the vehicle component is disposed onto the platform, and connecting the vehicle component to the vehicle frame. The vehicle component is partially located within the vehicle frame.

### FIELD

The present disclosure relates to a system and method for assembling a vehicle.

### BACKGROUND

The statements in this section merely provide background information related to the present disclosure and may not constitute prior art.

Conventional vehicle assembly processes are typically linear processes that involves sequential build of a vehicle body structure referred to as Body in White, followed by painting the body structure, and then securing vehicle components such as a power train assembly, suspension assemblies, and an instrument panel assembly, for example, to a vehicle structure (e.g., uni-body structure) as the vehicle structure moves along an assembly line. Assembly of vehicle components to the vehicle structure may be slowed down due to restricted access to the vehicle structure at different points along the assembly line.

The present disclosure addresses these issues related to the access to the vehicle structure to secure vehicle components thereto as the vehicle structure moves along the assembly line.

### SUMMARY

This section provides a general summary of the disclosure and is not a comprehensive disclosure of its full scope or all of its features.

In one form, the present disclosure provides a method for assembling a vehicle that includes disposing at least one vehicle component of the vehicle onto a platform, disposing a vehicle frame of the vehicle onto the platform after the vehicle component is disposed onto the platform, and connecting the vehicle component to the vehicle frame. The vehicle component is partially located within the vehicle frame.

In variations of the method of the above paragraph, which can be implemented individually or in any combination: the platform is movable in a vertical direction; the platform is movable in a horizontal direction; the method further includes moving the platform from a first position to a second position after the vehicle frame is disposed onto the platform, the platform being raised in the vertical direction from the first position to the second position; disposing the vehicle frame onto the platform comprises disposing the vehicle frame onto the platform from above such that the vehicle component is received through a floor opening of the vehicle frame; the method further includes disposing a tool onto the platform before disposing the vehicle frame onto the platform; the method further includes removing the vehicle frame comprising the vehicle component from the platform after the vehicle component is connected to the vehicle frame; disposing the vehicle component onto the platform comprises disposing a vehicle component structure onto the platform, the vehicle component structure includes that at least one vehicle component; the vehicle component structure includes at least one pocket, the vehicle contained in the at least one pocket; the vehicle component structure includes at least one upright panel, the vehicle component coupled to the upright panel; and the vehicle frame includes a plurality of pillars cooperating to form a door opening.

In another form, the present disclosure provides a method for assembling a vehicle that includes disposing at least one vehicle component structure onto a platform, disposing a vehicle frame of the vehicle onto the platform from above such that the vehicle component structure is received through a floor opening of the vehicle frame and the plurality of vehicle components are at least partially located within the vehicle frame, and connecting the plurality of vehicle components to the vehicle frame. The vehicle component structure includes a plurality of vehicle components of the vehicle.

In variations of the method of the above paragraph, which can be implemented individually or in any combination: the platform is movable in a vertical direction; the method further includes removing the vehicle frame comprising the vehicle components from the platform after the vehicle components are connected to the vehicle frame; the vehicle component structure includes at least one pocket, a first vehicle component of the vehicle components contained in the pocket; the vehicle component structure includes at least one upright panel, a second vehicle component of the vehicle components coupled to the upright panel; the vehicle component structure includes at least one upright panel, a first vehicle component of the vehicle components coupled to the upright panel; and the vehicle frame includes a plurality of pillars cooperating to form at least one door opening.

In another form, the present disclosure provides a system for assembling a vehicle. The system includes a platform, a vehicle component structure, a robot, and a controller. The vehicle component structure is configured to support a plurality of vehicle components. The controller is in communication with the robot and the platform. The controller configured to instruct the robot to move the vehicle component structure onto the platform based on data received and instruct the robot to move a vehicle frame of the vehicle onto the platform from above such that the vehicle component structure is received through a floor opening of the vehicle frame and the plurality of vehicle components are partially received within the vehicle frame. In some forms of the above paragraph, the vehicle component structure includes at least one pocket configured to support a first vehicle component of the vehicle components and an upright panel configured to support a second vehicle component of the vehicle components.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a vehicle frame of a vehicle located on a platform having a component structure according to the principles of the present disclosure;

FIG. 2 is a perspective view of the platform of FIG. 1;

FIG. 3 is a perspective view of the vehicle frame of FIG. 1;

FIG. 4 is a perspective view of the component structure of FIG. 1 including components;

FIG. 5 is another perspective view of the component structure of FIG. 1 without components;

FIG. 6A-6E is various steps showing the vehicle of FIG. 1 being assembled;

FIG. 7 is a functional block diagram of a system in accordance with the present teachings of the present disclosure; and

FIG. 8 is a flowchart depicting an algorithm for assembling the vehicle in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

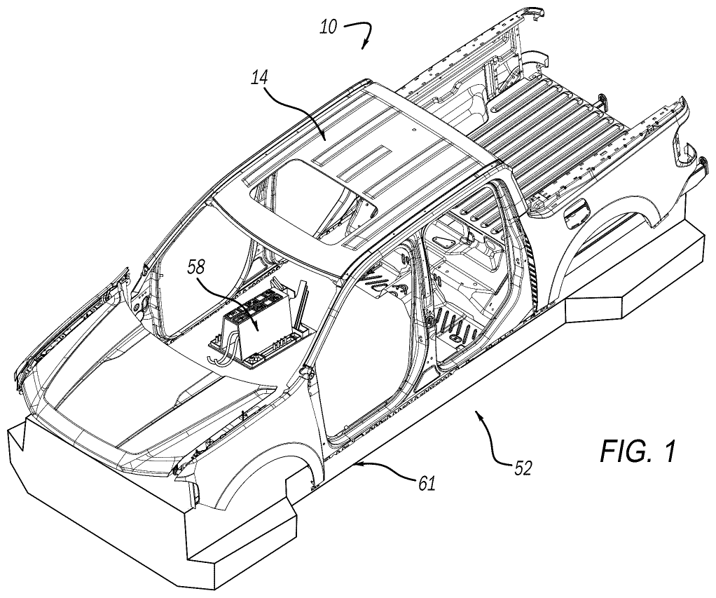

With reference to FIG. 1, a frame or structure 14 of a vehicle 10 such as an electric vehicle is provided. In the example provided, the electric vehicle is a battery electric vehicle (BEV). In other examples, the electric vehicle may be a hybrid electric vehicle (HEV), a plug-in electric vehicle (PHEV), or a fuel cell vehicle. In still other examples, the vehicle 10 may be an internal combustion engine driven vehicle.

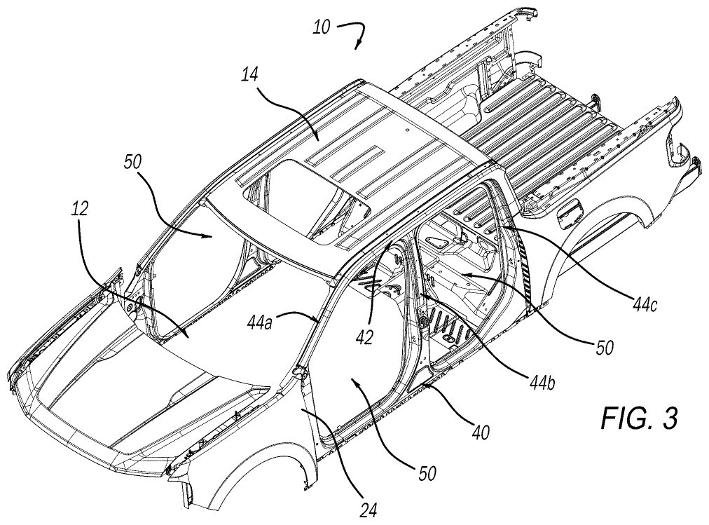

In one example, the vehicle structure 14 is manufactured using a plurality of stamped parts that are secured to each other, e.g., via welding, adhesive, or fasteners. In another example, the vehicle structure 14 is manufactured using a casting process. With reference to FIG. 3, the vehicle structure 14 includes, inter alia, a pair of hinge pillars 24 (only one shown in the figures), a pair of inner rails (not shown), a pair of upper rails (not shown), rockers 40, upper side rails 42, and a plurality of pillars (e.g., a pair of front pillars 44a, a pair of middle pillars 44b, and a pair of rear pillars 44c). Each hinge pillar 24 extends in a vertical direction from an end of a respective front pillar 44a to an end of a respective rocker 40. Each inner rail extends from a lower portion of a respective hinge pillar 24 to a bumper (not shown). Each inner rail can also be arcuate and extend around a front wheel of the vehicle frame 14 and form a portion of a respective front wheel well. The upper rails are positioned above the pair of inner rails and extend from an upper portion of a respective hinge pillar 24 toward a front of the vehicle 10.

The rockers 40 extend lengthwise in a longitudinal direction of the vehicle 10 and may be configured to mount a battery pack (not shown) to the vehicle structure 14. Each rocker 40 is made of a metal material such as aluminum, for example, and may be secured to a respective side of the battery pack using fasteners, adhesives, welding, or any other suitable attachment means, for example.

Each upper side rail 42 is positioned at a side of the rear vehicle structure 14 and extends along the longitudinal direction of the vehicle 10. Each side rail 42 includes one or more structural members extending along the longitudinal direction of the vehicle 10. Each front pillar 44a extends in the longitudinal direction of the vehicle 10 from a respective side rail 42 to a respective hinge pillar 24. Each middle pillar 44b extends in a vertical direction from a respective side rail 42 to a respective rocker 40. Each rear pillar 44c extends toward a rear of the vehicle 10 from an end of a respective side rail 42. The front pillars 44a, the middle pillars 44b, the hinge pillars 24a, 24b, the rockers 40 and the side rails 42 cooperate to define door openings 50 in the vehicle structure 14. Doors (not shown) are rotatably coupled to the vehicle structure 14 and rotatable between a closed position in which the doors are disposed within the door openings 50 and an open position in which the doors are removed from the door openings 50.

It should be understood that other components may be coupled to the vehicle structure 14 such as a floor and battery assembly (not shown). A battery pack (not shown) of the floor and battery assembly may be rechargeable and may include lithium-ion batteries or any other suitable electrical power storage units. The battery pack may be received in a floor opening 12 of the vehicle frame 14 and mounted to various locations of the vehicle structure 14. In this way, the battery pack is supported by the vehicle structure 14 and is remote from a passenger cabin (not shown) and cargo compartments (not shown) of the vehicle 10, therefore, not occupying space that would otherwise be available for passengers or cargo. One example of such battery pack is disclosed in U.S. patent application Ser. No. 17/980,208 titled “STRUCTURAL ASSEMBLY FOR BATTERY STRUCTURE OF ELECTRIC VEHICLE” which is commonly owned with the present application and the contents of which are incorporated herein by reference in its entirety.

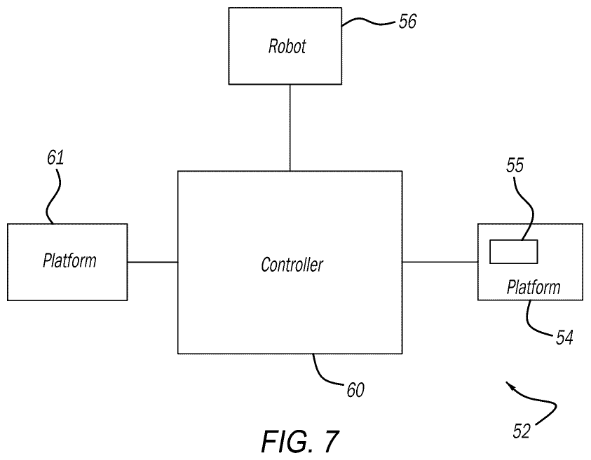

The present disclosure includes a system 52 for assembling the vehicle 10. The system 52 includes a platform 54, a robot 56 (FIG. 7), a vehicle component structure 58, and a controller 60 (FIG. 7). In the example, the platform 54 may be configured to receive and support the vehicle component structure 58 and can be movable in a plurality of directions. In one form, the platform 54 is movable between a first position in which the platform 54 is at a first height from a floor, and a second position in which the platform 54 is at a second height from the floor that is greater than the first height. Stated differently, the platform 54 is movable via an actuator 55 (FIG. 7) in a vertical direction between the first position and second position. The actuator 55 may be a hydraulic actuator or an electronic actuator, for example. In another form, the platform 54 may be movable in a horizontal direction. In the example illustrated, the platform 54 is located on a robot platform 61 that may be configured to support the vehicle structure 14 as will be described in more detail below. In one form, the robot platform 61 is stationary. In another form, the robot platform 61 moves along the floor in a predetermined pattern (e.g., circular pattern or linear pattern).

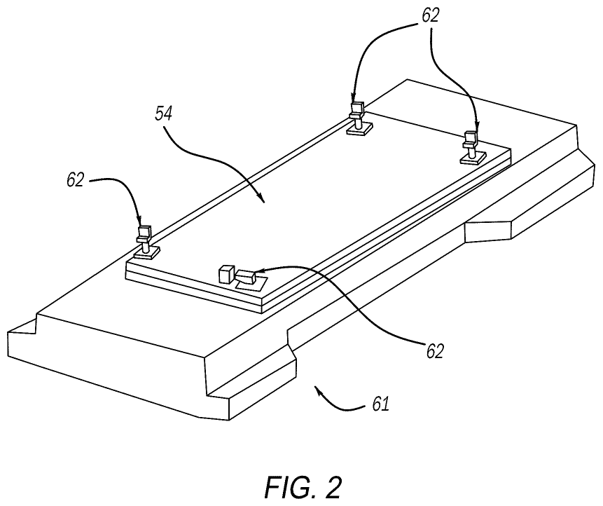

With reference to FIG. 2, the platform 54 may include mounting features 62 that support the vehicle component structure 58. That is, the mounting features 62 may support the vehicle component structure 58 on the platform 54 such that the vehicle component structure 58 is spaced apart from the platform 54 (e.g., spaced apart from an upper surface of the platform). In the example illustrated, the mounting features 62 are located at respective corners of the platform 54. In some forms, the mounting features 62 are connected to the platform 54 at other locations of the platform 54 (e.g., a central portion of the platform 54) to support the vehicle component structure 58. The mounting features 62 may include pins and apertures, for example, to align and inhibit movement of the vehicle component structure 58 on the platform 54.

The robot 56 (FIG. 7) includes a robot arm (not shown) and a robotic gripper structure (not shown). The robot arm includes a plurality of segments connected to each other at joints, thereby allowing the robot 56 to have multiple degrees of freedom. In some forms, the robot 56 is partially or fully autonomous and is configured to autonomously move to the platform 54 as instructed by the controller 60. To autonomously move itself, the controller 60 is configured to control various movement systems of the robot 56 based on location data obtained from one or more sensors. In an example application, the movement systems may include propulsion systems, steering systems for controlling wheels, and the sensors for providing location data may include a GNSS sensor, an imaging sensor, a local position sensor, among others. The robotic gripper structure is secured to the robot arm and is configured to grasp and move the vehicle component structure 58 from a part support to the platform 54 and/or grasp and move the vehicle structure 14 from a part support to the platform 61. In some forms, the robot 56 may be configured to grasp and move the vehicle component structure 58 and another robot (not shown) may grasp and move the vehicle structure 14 without departing from the scope of the present disclosure.

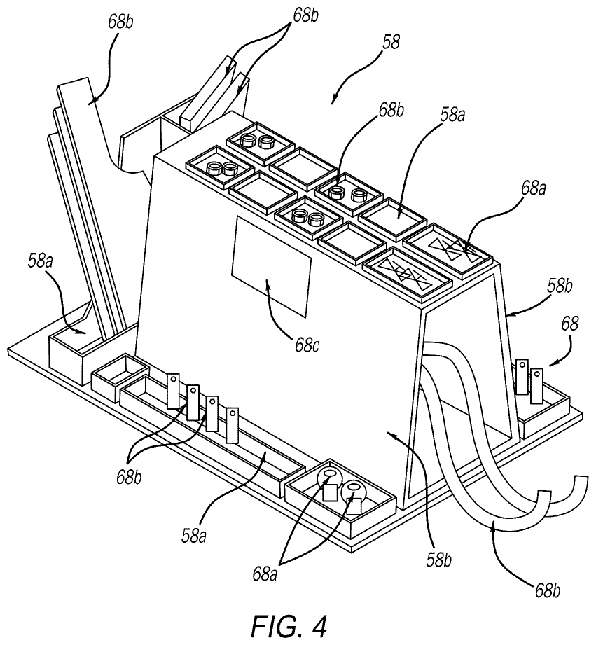

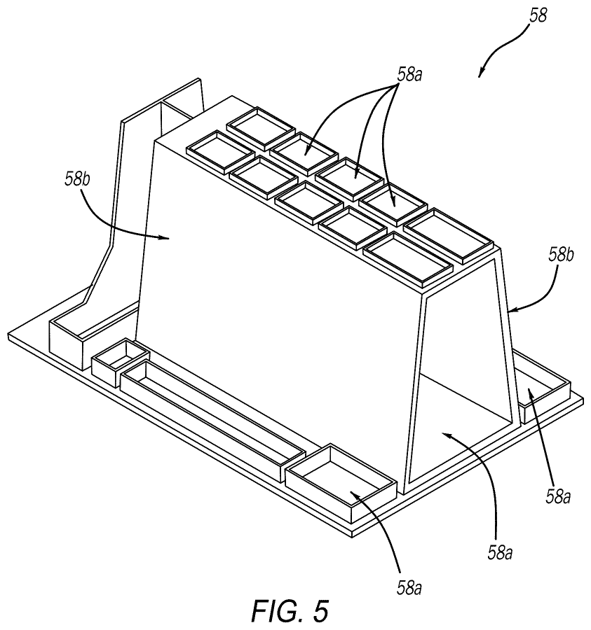

With reference to FIGS. 4 and 5, the vehicle component structure 58 may be made of a plastic material, a metal material, a composite or any suitable lightweight, durable material. The vehicle component structure 58 may also be configured to support a plurality of components 68 thereon such as tool components 68a, vehicle components 68b, instructional components 68c and more. Stated differently, the tool components 68a may include drills and wrenches, for example. The part components 68b may include pillar panels, wire harnesses, conduits, fasteners, vehicle modules, clips and more. The instructional components 68c may be tablets, instruction guides and/or other components that facilitate assembly of the vehicle 10. The vehicle component structure 58 includes at least one pocket 58a and at least one upright panel 58b. In the example illustrated, the vehicle component structure 58 includes a plurality of pockets 58a and a plurality of upright panels 58b. The pockets 58a may be configured to receive and contain components 68a, 68b such as drills, fasteners, modules, clips, and panels, for example. The upright panels 58b may extend upward further than the pockets 58a and may be configured to support components 68a, 68b, 68c such as drills, tablets, instruction guides, pillar panels and more. For example, the instruction guide and/or tablet may be coupled to the upright panels 58b such that the instruction guide and tablet are accessible to an operator or robot during assembly of the vehicle 10. In another example, fasteners or pillar panels may be coupled to the upright panels 58b such that the components are accessible to an operator or robot during assembly of the vehicle 10. In the example illustrated, the upright panels 58b are inclined or at an angle to support larger components 68 while also allowing the vehicle component structure 58 to be received within the vehicle structure 14. In the example illustrated, the upright panels 58b are inclined vertically from an outer portion of the component structure 58 toward a center portion of the component structure 58. In this way, packaging of more components onto the component structure 58 is facilitated and the component structure 58 is conveniently received within the vehicle frame 14 as will be described in more detail below.

With reference to FIG. 7, the controller 60 is in communication with the robot 56 and the platforms 54, 61, and may monitor and control operations of the robot 56 and the platforms 54, 61 based on data received. In one example, the controller 60 is in communication with the robot 56 and the platforms 54, 61 using a wired or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

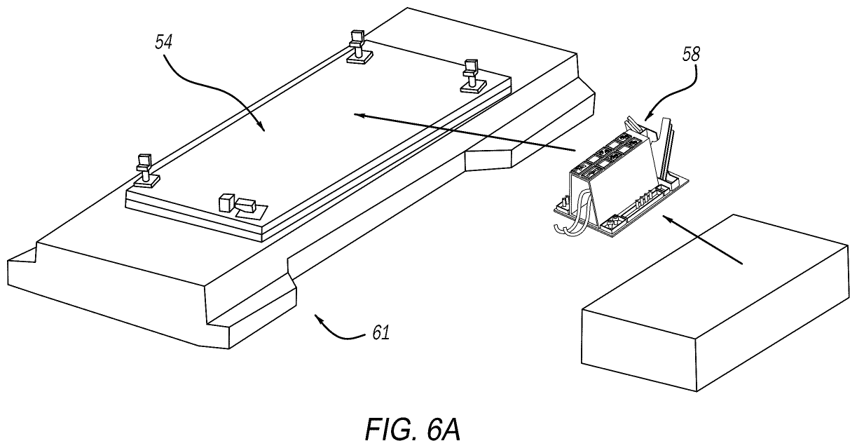

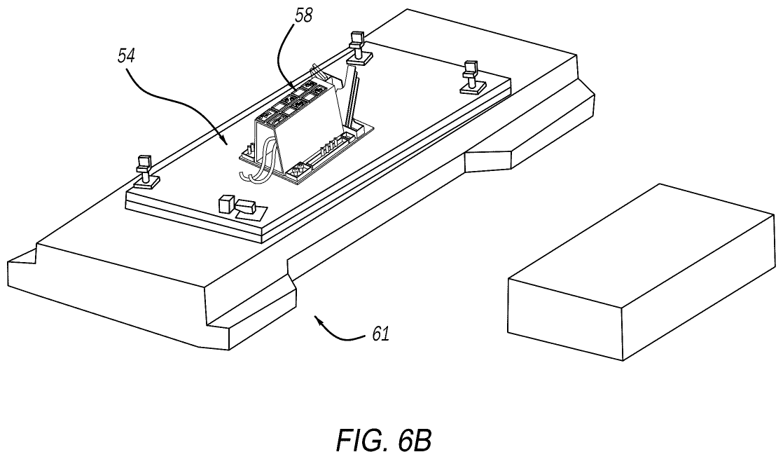

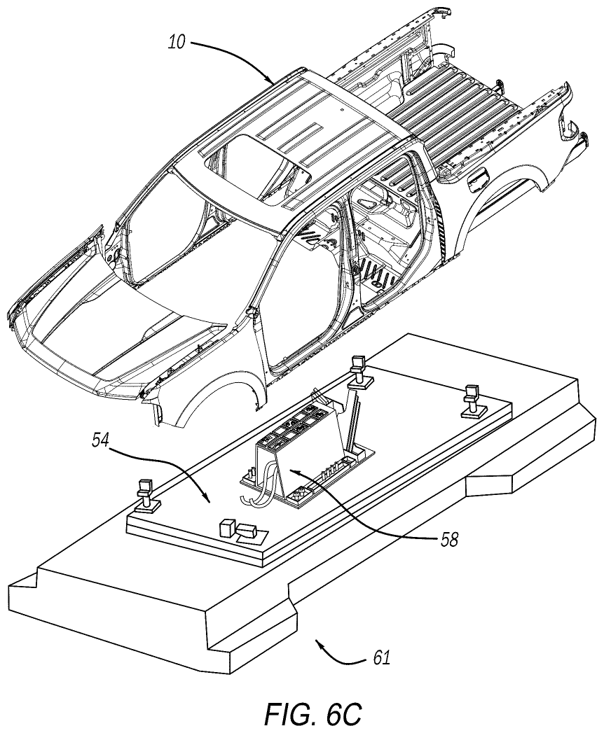

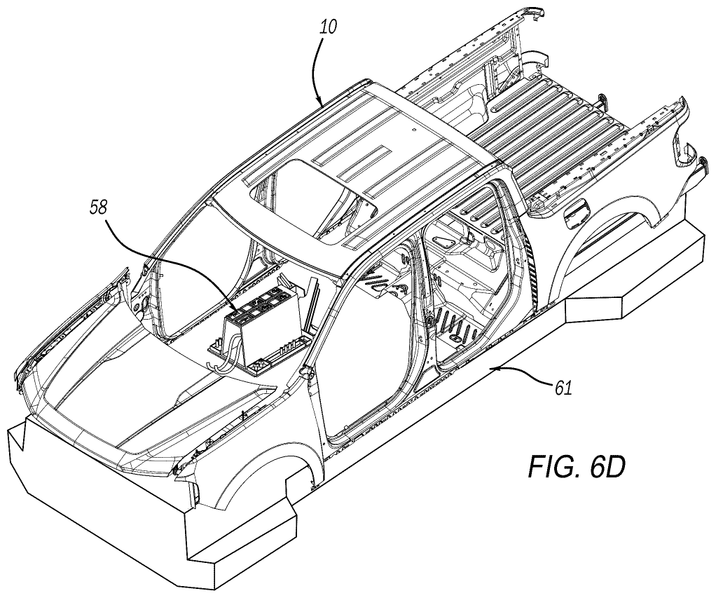

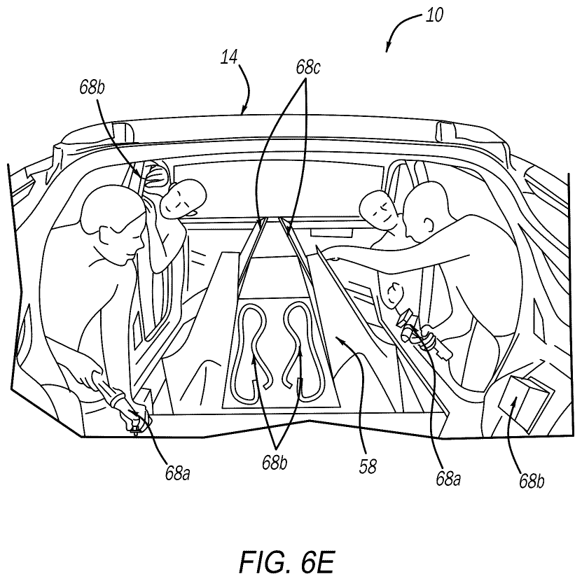

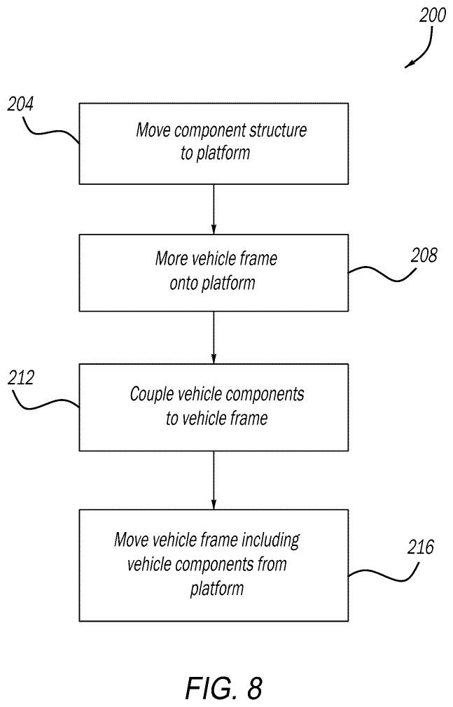

Referring to FIGS. 6A-6E and 8, an example control algorithm 200 for assembling a vehicle 10 is illustrated. The assembly may begin once the components 68 are loaded into the vehicle component structure 58, for example. At 204, the control algorithm, using the controller 60, instructs the robot 56 to move the vehicle component structure 58 including the components 68 to the platform 54 based on data received (FIGS. 6A and 6B). In one form, the data received may be signals/data indicating that the components have been coupled to the vehicle component structure 58. In another form, the data received may be signals/data indicating that the vehicle structure 14 is ready to be moved onto the robot platform 61. In the example illustrated, the platform 54 is located on the robot platform 61. In some forms, the platform 54 may be located on a conveyor, floor, or another other object/location where the vehicle 10 is being assembled. In some forms, the vehicle component structure 58 including the components 68 may be moved to the platform 54 manually instead of using the robot 56. In such forms, the vehicle component structure 58 may be moved to the platform 54 without the components 68, then the components 68 may be coupled to (e.g., loaded on) the component structure 58 at the platform 54.

At 208, the control algorithm, using the controller 60, instructs the robot 56 to move the vehicle structure 14 onto the robot platform 61 (FIGS. 6C and 6D). The vehicle structure 14 is moved onto the robot platform 61 from above such that the vehicle component structure 58 is received through the floor opening 12 of the vehicle frame 14 and the vehicle component structure 58 including the components 68 are at least partially located within the vehicle frame 14. In some forms, a different robot (e.g., overhead crane) may move the vehicle frame 14 onto the robot platform 61 from above. In other forms, the controller 60 moves the platform 54 from a first position to a second position after the vehicle frame 14 is disposed onto the platform 61. Stated differently, the platform 54 may be raised in the vertical direction from the first position to the second position after the vehicle frame 14 is disposed onto the platform 61. In this way, the vehicle frame 14 may be conveniently positioned over the component structure 58 in a first step while also allowing the components 68 to be moved to a location where they are more accessible after the component structure 58 is within the vehicle frame 14.

At 212, the vehicle components 68b may be coupled to the vehicle frame 14 using the tool components 68a and the instructional components 68c (FIG. 6E). In some forms, robots may use the tool components 68a (e.g., wrenches, drills, etc.) to connect/secure the vehicle components 68b (e.g., fasteners, pillar panels, etc.) to the vehicle frame 14. In other forms, operators (not shown) may use the tool components 68a and the instructional components 68c to connect/secure the vehicle components 68b to the vehicle frame 14.

At 216, the vehicle frame 14 comprising the vehicle components 68b may be removed from the platform 61 after the vehicle components 68b are connected to the vehicle frame 14. The vehicle frame 14 comprising the vehicle components 68b may be moved to the next station in the assembly process and the component structure 58 may be moved to a station where additional vehicle components 68b are coupled thereto for the next vehicle frame.

The present disclosure provides the benefit of permitting multiple operators/robots to work simultaneously to secure vehicle components 68b to the vehicle frame 14. For example, one or more operators may be simultaneously located at each of a front of the vehicle frame 14, a rear of the vehicle frame 14, and respective sides of the vehicle frame 14 to secure the vehicle components 68b to the vehicle frame 14. The present disclosure also provides the benefit of moving the components 68 from around the vehicle frame 14 to within the vehicle frame 14. This eliminates lineside racks and conveyance lanes, which may reduce the footprint of the manufacturing assembly. Moving the components 68 within the vehicle frame 14 also reduces the movement of the operators between the vehicle frame 14 and the components 16. That is, operators may be located at respective door openings 51 of the vehicle frame 14 where the operators may quickly and conveniently access the components 68. In this way, the operators may use the tool components 68a and instructional components 68c to couple the vehicle components 68b to the vehicle frame 14.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for assembling a vehicle, the method comprising:
disposing at least one vehicle component of the vehicle onto a platform;
disposing a vehicle frame of the vehicle onto the platform after the at least one vehicle component is disposed onto the platform, the at least one vehicle component being partially located within the vehicle frame; and
connecting the at least one vehicle component to the vehicle frame.

2. The method of claim 1, wherein the platform is movable in a vertical direction.

3. The method of claim 2, wherein the platform is movable in a horizontal direction.

4. The method of claim 2, further comprising moving the platform from a first position to a second position after the vehicle frame is disposed onto the platform, the platform being raised in the vertical direction from the first position to the second position.

5. The method of claim 1, wherein disposing the vehicle frame onto the platform comprises disposing the vehicle frame onto the platform from above such that the at least one vehicle component is received through a floor opening of the vehicle frame.

6. The method of claim 1, further comprising disposing a tool onto the platform before disposing the vehicle frame onto the platform.

7. The method of claim 1, removing the vehicle frame comprising the at least one vehicle component from the platform after the at least one vehicle component is connected to the vehicle frame.

8. The method of claim 1, wherein disposing the at least one vehicle component onto the platform comprises disposing a vehicle component structure onto the platform, the vehicle component structure includes that at least one vehicle component.

9. The method of claim 8, wherein the vehicle component structure includes at least one pocket, the at least one vehicle component contained in the at least one pocket.

10. The method of claim 8, where the vehicle component structure includes at least one upright panel, the at least one vehicle component coupled to the at least one upright panel.

11. The method of claim 1, wherein the vehicle frame includes a plurality of pillars cooperating to form a door opening.

12. A method for assembling a vehicle, the method comprising:
disposing at least one vehicle component structure onto a platform, the at least one vehicle component structure including a plurality of vehicle components of the vehicle;
disposing a vehicle frame of the vehicle onto the platform from above such that the at least one vehicle component structure is received through a floor opening of the vehicle frame and the plurality of vehicle components are at least partially located within the vehicle frame; and
connecting the plurality of vehicle components to the vehicle frame.

13. The method of claim 12, wherein the platform is movable in a vertical direction.

14. The method of claim 12, removing the vehicle frame comprising the vehicle components from the platform after the vehicle components are connected to the vehicle frame.

15. The method of claim 12, wherein the at least one vehicle component structure includes at least one pocket, a first vehicle component of the vehicle components contained in the at least one pocket.

16. The method of claim 15, where the at least one vehicle component structure includes at least one upright panel, a second vehicle component of the vehicle components coupled to the at least one upright panel.

17. The method of claim 12, where the at least one vehicle component structure includes at least one upright panel, a first vehicle component of the vehicle components coupled to the at least one upright panel.

18. The method of claim 12, wherein the vehicle frame includes a plurality of pillars cooperating to form at least one door opening.

19. A system for assembling a vehicle, the system comprising:
a platform;
a vehicle component structure configured to support a plurality of vehicle components;
a robot; and
a controller in communication with the robot and the platform, the controller configured to:
instruct the robot to move the vehicle component structure onto the platform based on data received; and
instruct the robot to move a vehicle frame of the vehicle onto the platform from above such that the vehicle component structure is received through a floor opening of the vehicle frame and the plurality of vehicle components are partially received within the vehicle frame.

20. The system of claim 19, wherein the vehicle component structure includes at least one pocket configured to support a first vehicle component of the vehicle components and an upright panel configured to support a second vehicle component of the vehicle components.
